(19) United States
(12) Patent Application Publication
(10) Pub. No.: US 2023/0174879 A1
(43) Pub. Date: Jun. 8, 2023

(54) METHOD FOR PRODUCING RENEWABLE NATURAL GAS FROM BIOGASES CONTAINING VOLATILE ORGANIC COMPOUNDS

(71) Applicant: Stearns, Conrad and Schmidt, Consulting Engineers, Inc., Reston, VA (US)

(72) Inventor: Jeffrey PIERCE, Torrance, CA (US)

(73) Assignee: Stearns, Conrad and Schmidt, Consulting Engineers, Inc., Reston, VA (US)

(21) Appl. No.: 17/870,214

(22) Filed: Jul. 21, 2022

Related U.S. Application Data
(60) Provisional application No. 63/285,194, filed on Dec. 2, 2021.

(51) Int. Cl. C10L 3/10

(52) U.S. Cl. CPC C10L 3/101; C10L 2200/0469; C10L 2290/12; C10L 2290/542

(57) ABSTRACT

A method for production of renewable natural gas (RNG) from biogases containing volatile organic compounds (VOCs) combines temperature swing adsorption (TSA) for removal of VOCs, a form of pressure swing adsorption (PSA) for nitrogen separation, and membrane gas separation technology for carbon dioxide removal. TSA systems may improve removal of VOCs relative to PSA systems, may reduce RNG plant operating costs, and may simplify RNG plant operation. Methane recovery may be improved by using equilibrium PSA systems instead of dynamic PSA systems for methane separation.

### BACKGROUND

Biogas is a waste gas, or a gas intentionally produced, from the biological degradation of organic waste. Biogas can be converted into a pipeline quality natural gas equivalent through removal of unacceptable constituents. Biogas that is converted into a natural gas equivalent is known as renewable natural gas (RNG). Unacceptable constituents, present on a percentage basis in biogas, include carbon dioxide, nitrogen, water, and oxygen. Volatile organic compounds (VOCs), which are present in concentrations of parts per million volumetric (ppmv), must also be removed. The most abundant source of biogas currently available is landfill gas. As compared to other biogases, landfill gas has elevated concentrations of VOCs.

Complex process chains are required to remove unacceptable constituents from biogas. The most widely used technology for carbon dioxide removal is membrane technology. The most widely used technology for nitrogen removal, when required, is pressure swing adsorption (PSA) technology. Most landfill gas RNG projects require nitrogen removal.

VOCs are problematic for two reasons. First, pipeline natural gas companies that receive RNG are promulgating increasingly restrictive limits on VOCs. Second, without very effective removal of VOCs early in the RNG plant process chain, the VOCs slipping forward will cause an unacceptably high loss in methane recovery and increased downstream operation and maintenance costs. RNG, being a low carbon fuel, has sold at a price as high as $35 per million British thermal units (Btus) in recent years, or ten times the value of conventional natural gas. The problems of loss of methane recovery and increased operation and maintenance cost occur when using PSAs for nitrogen removal. The cause of these problems is contamination of the nitrogen removal PSA media with VOCs.

Virtually all operating RNG plants employing membrane carbon dioxide removal technology to process landfill gas employ an upfront PSA VOC removal system coupled with two lead-lag activated carbon vessels. This VOC removal system is disclosed in U.S. Pat. No. 7,025,803. The PSA VOC removal system disclosed under U.S. Pat. No. 7,025,803 employs waste gas carbon dioxide from the membranes to regenerate the PSA media. The PSA media removes the bulk of the VOCs, the removal of which may be about 90 to 95 percent. The activated carbon vessels remove the remaining VOCs. The activated carbon media is non-regenerative. Replacement of the activated carbon media is required after it becomes saturated with VOCs.

U.S. Pat. No. 7,731,779 discloses an RNG production process employing membrane carbon dioxide removal followed by PSA nitrogen removal. A dynamic PSA removes nitrogen from the gas stream as the method of methane separation. A dynamic PSA only achieves a methane recovery of 85 percent.

U.S. Pat. No. 4,770,676 discloses a process for producing RNG from landfill gas which employs a Temperature Swing Adsorption (TSA) system for VOC removal followed by a PSA system for carbon dioxide removal. Pat. No. 4,770,676 does not include a nitrogen removal system after the carbon dioxide removal system.

### SUMMARY

According to an exemplary embodiment, an improved method for production of renewable natural gas from biogases containing volatile organic compounds may be provided. The improved method may include providing landfill gas to a conditioning unit and conditioning the landfill gas, compressing the landfill gas, adjusting the temperature of the landfill gas, and removing volatile organic compounds from the landfill gas. The landfill gas may then be processed using a membrane carbon dioxide removal system and then equilibrium pressure swing adsorption system for nitrogen removal. The method may then include the delivering waste gases to a thermal oxidizer. The resulting renewable natural gas may then be provided for distribution.

According to another exemplary embodiment, a system for production of renewable natural gas from biogas may be provided. The system may include a gas conditioning unit, a gas compression unit after the gas conditioning unit along a gas flow path, a gas cooling unit after the gas compression unit along the gas flow path, and a volatile organic compound removal unit after the gas cooling unit along the gas flow path. The system may further include a membrane carbon dioxide removal unit after the volatile organic compound removal unit along the gas flow path, an equilibrium pressure swing adsorption unit after the membrane carbon dioxide removal unit along the gas flow path, a product gas compressor, and a thermal oxidizer.

### BRIEF DESCRIPTION OF THE FIGURE

Advantages of embodiments of the present invention will be apparent from the following detailed description of the exemplary embodiments. The following detailed description should be considered in conjunction with the accompanying figure in which:

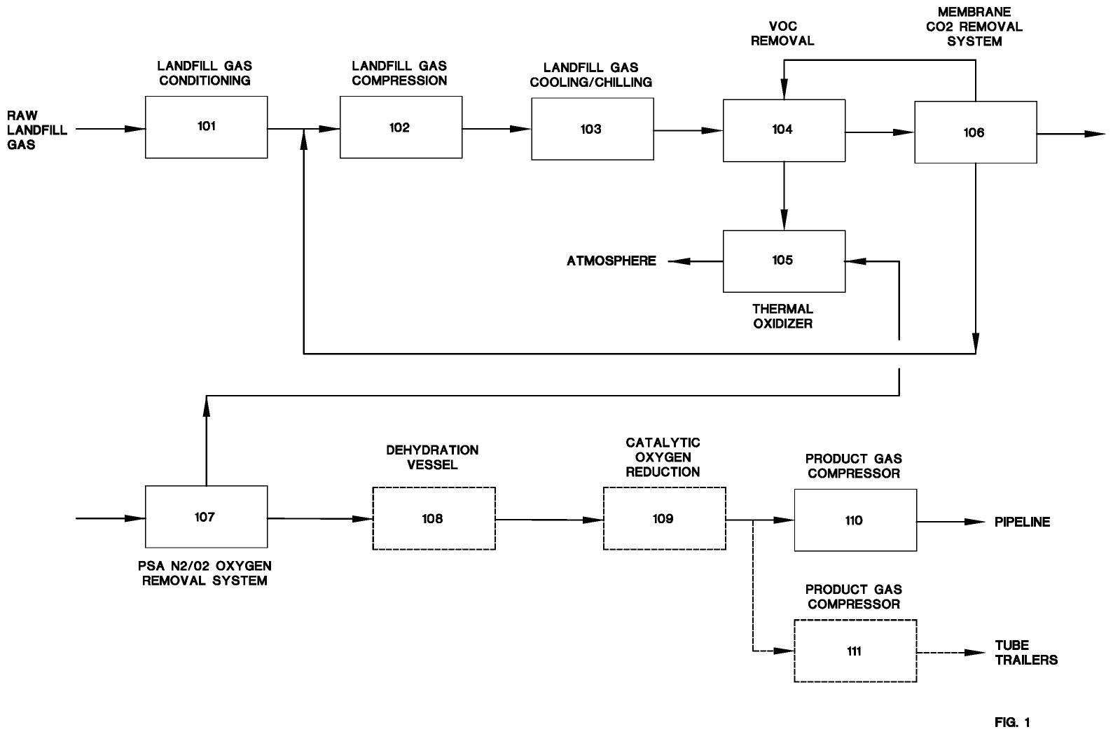

Exemplary FIG. 1 shows a method of producing RNG from biogases containing VOCs.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

An improved method and system for production of renewable natural gas from biogases containing volatile organic compounds (VOCs) combines a form of temperature swing adsorption (TSA), membrane gas separation technology and a form of pressure swing adsorption (PSA) technology.

The present method and system presents an improvement over the PSA VOC removal system disclosed in U.S. Pat, No. 7,025,803 by using a temperature swing (TSA) VOC removal system. At least two major advantages over the PSA VOC removal system may be provided by the present method and system. First, the TSA VOC removal system may remove about 99.95 percent of the VOCs, and does not require the lead-lag activated carbon vessels. The TSA VOC removal system provides better long-term protection against VOCs slipping forward than the PSA VOC removal system and therefore avoids the adverse consequences of VOC forward slippage. The PSA VOC removal system requires an intermittent, high pressure, high flow blowdown, to the inlet of the RNG process chain. The blowdown occurs several times per hour. The blowdown is disruptive to the operation of the landfill gas collection system at the landfill, causes instability in the operation of RNG plant process chain, and requires that the front end RNG process chain capacity be increased by ten percent to handle the blowdown.

The present disclosure also differs from U.S. Pat. No. 7,731,779 in at least two ways. First, the presently disclosed method and system employ a TSA system rather than a PSA system for VOC removal, with the benefits resulting as described herein. Second, the PSA nitrogen removal technology employed in the present disclosure is an equilibrium PSA, rather than a dynamic PSA. A dynamic PSA removes nitrogen from the gas stream as the method of methane separation. A dynamic PSA only achieves a methane recovery of 85 percent. An equilibrium PSA removes methane from the gas stream, as the method of methane separation. An equilibrium PSA achieves a methane recovery of 98 to 99 percent. The much higher methane recovery of an equilibrium PSA significantly increases RNG revenue.

Furthermore, the improved method and system differ from the disclosure of U.S. Pat. No. 4,770,676 in at least two ways. First, the improved method and system employ a TSA VOC removal/membrane carbon dioxide removal system, not TSA VOC removal/PSA carbon dioxide removal system. Second, the improved method and system add a PSA nitrogen removal system to the carbon dioxide removal system.

Referring now to FIG. 1, an improved method and system for production of renewable natural gas (RNG) from biogases containing volatile organic compounds may be provided. The method may combine a form of TSA, membrane gas separation technology and a form of PSA technology.

Raw biogas, which may include landfill gas from a landfill, may be provided in a first step. The biogas may be conditioned in a gas conditioning 101 step. Biogas conditioning 101 may include one or more low-pressure blowers, an air-to-gas cooler, hydrogen sulfide removal, and chilling for moisture removal. Biogas RNG plants may employ these biogas conditioning steps, with some modifications to suit a specific project. Different types of commercially available hydrogen sulfide removal technology may be used, based on the concentration of hydrogen sulfide in the biogas. In some exemplary embodiments, if the hydrogen sulfide concentration is low, hydrogen sulfide removal may not be employed. According to other exemplary embodiments, blowers and chilling may not be employed if the supplier of the biogas already provides pressurization and chilling.

Next may be a gas compression step. Biogas compression 102 increases the pressure of the biogas. According to some exemplary embodiments, the pressure may be increased from an approximate range of 3 to 8 psig to an approximate range of 200 to 300 psig. The pressure increase may depend on the membrane system, as would be understood by a person having ordinary skill in the art. The second-stage permeate from the membrane process may be recycled to the inlet of the biogas compressors to improve the methane recovery efficiency. The percentage of the biogas recycled may vary by membrane system.

After biogas compression, the biogas may undergo further moisture removal and temperature control 103. The biogas may be cooled in an air-to-gas cooler and then reheated to a desired temperature. According to at least one exemplary embodiment, the landfill gas may be cooled in an air-to-gas cooler, chilled to about 40° F. to about 45° F., and then reheated by about 10° F.

The landfill gas may be sent to a VOC removal step 104. This VOC removal step 104 may use activated carbon TSA technology. To avoid downstream VOC slippage, this VOC removal step 104 may reduce VOCs by more than 99.95 percent. Improved removal of VOCs may reduce the frequency and cost of replacement of the nitrogen removal PSA media, and may slow the deterioration of the PSA media maintaining higher rates of methane recovery.

The VOC removal step may incorporate one or more TSA VOC removal vessels filled with activated carbon. More specifically, according to an exemplary embodiment, the VOC removal step may incorporate two TSA VOC removal vessels filled with activated carbon. One vessel is in operation, while another vessel is in regeneration/standby. A vessel will typically operate for 12 hours before switching to regeneration. The period of operation may vary from eight hours to 24 hours, depending on the project specific design. The regeneration of a vessel consists of heating the activated carbon to approximately 400° F., holding the temperature at approximately 400° F., and then cooling the activated carbon down to approximately the ambient air temperature.

A portion of the waste carbon dioxide gas from the first-stage membranes may be used to heat and cool the vessel under regeneration. The waste carbon dioxide gas from the first-stage membranes, available at a pressure of approximately one to approximately two psig, may be increased in pressure by a low-pressure blower to deliver the waste carbon dioxide gas, in a counter-current flow, through the offline vessel to a thermal oxidizer 105.

The source of heat for heating the activated carbon may be an electric heater. Heating the activated carbon drives off the VOCs captured on the activated carbon and sends those VOCs to the thermal oxidizer for destruction. Cool down of the activated carbon may involve turning off the electric heater and continuing to run cool waste carbon dioxide gas through the activated carbon. The duration of the heat up and cool down cycle may be approximately twelve hours, but this may vary in a range of approximately eight hours to approximately sixteen hours.

In another exemplary embodiment, a non-regenerative activated carbon vessel may be added to the TSA VOC removal system to provide added protection against VOC slippage.

In another exemplary embodiment, a gas-to-gas heat exchanger in the thermal oxidizer may be employed to supply heat for activated carbon regeneration.

In yet another exemplary embodiment, the fraction of the waste carbon dioxide gas not used for TSA regeneration, which is free of VOCs and has a low methane content (about five percent), may be recovered for sale or for carbon dioxide sequestration.

The thermal oxidizer 105 may receive VOC-laden carbon dioxide gas from regeneration of the activated carbon, clean waste carbon dioxide and waste gas from the PSA nitrogen removal process. Thermal oxidizers require various amounts of supplemental fuel to support combustion at an approximate range of 1,400° F. to 1,600° F. to destroy VOCs and methane in these gas streams

After VOC removal, the biogas may be sent to a membrane carbon dioxide removal system 106. According to some exemplary embodiments, membrane carbon dioxide removal systems may be purchased or configured with three-stages or two-stages. Three-stage systems may increase methane recovery from about 96 percent to about 99 percent. In a three-stage configuration, the waste carbon dioxide gas still finds a single outlet to support the regeneration of the TSA activated carbon. Some membrane carbon dioxide removal systems may require interstage gas heating. When required, this heating may be supplied by the heat produced by the biogas compressors in a method prescribed according to the membrane carbon dioxide removal system specifications.

After carbon dioxide removal, the gas may proceed to nitrogen and oxygen removal employing an equilibrium PSA 107. An equilibrium PSA removes methane from the gas, leaving small quantities of carbon dioxide, nitrogen, and oxygen in the PSA product gas. The product gas then meets the definition of RNG. An equilibrium PSA may achieve a methane recovery as high as 99.5 percent.

In another exemplary embodiment, a dehydration vessel 108 may be added after the nitrogen removal PSA system. The purpose of the dehydration vessel is to remove moisture driven off from the PSA media which contains residual moisture from its manufacturing process. The release of this moisture over the first several weeks of initial use of the nitrogen removal PSA media, or after periodic media replacement, would cause the RNG to violate RNG quality standards for moisture, and necessitate that the RNG be temporarily disposed to a flare without value. The dehydration vessel allows all of the RNG to immediately enter the pipeline and be sold. The dehydration vessel may contain silica gel, activated alumina or other suitable non-regenerative desiccant sized to remove 100 percent of the moisture released from the nitrogen removal PSA media.

RNG from the process may be injected into a natural gas pipeline for distribution as a substitute for natural gas. In most cases, a product gas compressor 110 is required to increase product gas pressure to pipeline pressure. Pipeline pressures can be as high as 1,700 psig. Alternatively, RNG may be compressed to pressures as high as 4,000 psig and placed in tube trailers, or RNG may be liquefied, placed in trucks, and delivered to customers over the road rather than by pipeline 111.

Some pipeline companies have strict limits on oxygen. In such cases, additional oxygen removal 109 may be added to the process train. The most common form of oxygen removal is catalytic oxygen reduction. If catalytic oxygen reduction is added, the dehydration vessel 108 may be unnecessary because catalytic oxygen reduction may incorporate dehydration equipment.

Waste gas from the nitrogen removal PSA system may be combined with the waste gas from the membrane removal system and directed to the thermal oxidizer. Alternatively, waste gas from the nitrogen removal system could be used as a fuel for some types of power generation equipment or, if permitted by air regulations, could be directly discharged to the atmosphere.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for production of renewable natural gas (RNG) from landfill gas and other biogases containing volatile organic compounds (VOCs) comprising:
providing a landfill gas conditioning unit;
conditioning the landfill gas;
compressing the landfill gas;
removing moisture and adjusting a temperature of the landfill gas;
removing volatile organic compounds from the landfill gas with a temperature swing adsorption (TSA) unit;
delivering waste carbon dioxide gas to a thermal oxidizer;
processing the landfill gas using a membrane carbon dioxide removal system;
processing the landfill gas using equilibrium pressure swing adsorption (PSA); and
providing resulting RNG for distribution.

2. The method of claim 1, wherein conditioning comprises at least one of using low pressure blowers, using an air-to-gas cooler, hydrogen sulfide removal, and chilling for moisture removal.

3. The method of claim 1, wherein removing VOCs comprises using two TSA VOC removal vessels filled with activated carbon, wherein one vessel is in operation and a second vessel is in a regeneration or standby state.

4. The method of claim 3, wherein regeneration comprises heating the activated carbon to approximately 400° F. and subsequently cooling the activated carbon to approximately ambient air temperature.

5. The method of claim 1, wherein the membrane carbon dioxide removal system is a two-stage or three-stage system.

6. The method of claim 1, further comprising supplying heat for activated carbon regeneration from at least one of an electric heater and a gas-to-gas heat exchanger in the thermal oxidizer.

7. The method of claim 1, further comprising recovering waste carbon dioxide for sale or carbon dioxide sequestration.

8. A system for production of renewable natural gas from biogas comprising:
a gas conditioning unit;
a gas compression unit after the gas conditioning unit along a gas flow path;
a gas cooling unit after the gas compression unit along the gas flow path;
a VOC removal unit after the gas cooling unit along the gas flow path;
a membrane carbon dioxide removal unit after the VOC removal unit along the gas flow path;
an equilibrium pressure swing adsorption unit after the membrane carbon dioxide removal unit along the gas flow path;
a product gas compressor; and
a thermal oxidizer.

9. The system of claim 8, wherein the gas conditioning unit comprises at least one of low pressure blowers, air-to-gas coolers, hydrogen sulfide removal, and chilling for moisture removal.

10. The system of claim 8, wherein the VOC removal unit comprises two TSA removal removal vessels filled with activated carbon.

11. The system of claim 10, wherein the activated carbon in the TSA VOC removal vessels is heated and cooled to regenerate the activated carbon.

12. The system of claim 11, wherein the TSA VOC removal vessels are configured to operate in a state where one TSA removal vessel is in an operating state and one removal vessel is in a regeneration state.

13. The system of claim 8, wherein the membrane carbon dioxide removal system is a two-stage or three-stage system.

14. The system of claim 8, wherein the thermal oxidizer comprises a gas-to-gas heat exchanger configured to supply heat for activated carbon regeneration.
